(19) United States
(12) Patent Application Publication
(10) Pub. No.: US 2025/0214155 A1
(43) Pub. Date: Jul. 3, 2025

(54) DRILL AND METHOD OF MANUFACTURING MACHINED PRODUCT

(71) Applicant: KYOCERA CORPORATION, Kyoto (JP)

(72) Inventor: Masahiko KURODA, Kyoto (JP)

(21) Appl. No.: 18/848,515

(22) PCT Filed: Mar. 1, 2023
(86) PCT No.: PCT/JP2023/007565

§ 371 Date: Sep. 19, 2024

(30) Foreign Application Priority Data
Mar. 24, 2022 (JP) 2022-048639

(51) Int. Cl. B23B 51/02

(52) U.S. Cl. CPC B23B 51/02; B23B 2251/40

(57) ABSTRACT

To provide a drill having high rigidity and excellent chip discharging property while reducing the occurrence of damage on a front end side. A drill according to one aspect of the present disclosure includes a body extending along a rotation axis. The body has a cutting edge, a thinning flute, a discharge flute, a front end surface, a first honing surface, and a second honing surface connected to the first honing surface. The first honing surface includes a first portion that is connected to the second honing surface and that has a width that increases toward the second honing surface in a front end view. The second honing surface includes a second portion that is connected to the first honing surface and that has a width that increases toward the first honing surface in a front end view.

### TECHNICAL FIELD

The present aspect relates to a drill and a method of manufacturing a machined product.

### BACKGROUND OF INVENTION

As drills used to perform milling on a workpiece, for example, drills disclosed in Patent Documents 1 and 2 are known. As in the drills described in Patent Documents 1 and 2, by performing chamfering or honing on a boundary portion between a flank face and a flute located on a front end side of a drill, effects such as suppressing the occurrence of stress concentration during machining and enhancing the chip discharging property of the drill can be obtained.

Specifically, in the drill described in Patent Document 1, a curved portion is formed on the flank face, and thus a great advantage is that the load of a drill cutting edge during drilling is reduced. In the drill described in Patent Document 2, it is disclosed that the chip discharging property is further enhanced by rounding a heel portion located on the front end side of the drill with a round surface.

### CITATION LIST

### Patent Literature

Patent Document 1: WO 2001/036134 A
Patent Document 2: JP 03-040499 UM-B

### SUMMARY

A drill according to an aspect of the present disclosure includes a body that is rod-shaped and that extends from a front end toward a rear end along a rotation axis. The body includes a cutting edge located on the front end side, a thinning flute extending from the cutting edge toward the rear end, a discharge flute located on an outer peripheral side of the thinning flute and extending from the cutting edge toward the rear end, a front end surface adjacent to the thinning flute and the discharge flute rotationally in front of the rotation axis, a first honing surface located at an intersection of the front end surface and the thinning flute, and a second honing surface located at an intersection of the front end surface and the discharge flute, and connected to the first honing surface. The first honing surface includes a first portion that is connected to the second honing surface and that has a width that increases toward the second honing surface in a front end view. The second honing surface includes a second portion that is connected to the first honing surface and that has a width that increases toward the first honing surface in the front end view.

### BRIEF DESCRIPTION OF THE DRAWINGS

FIG. 1 is a perspective view illustrating a drill according to an embodiment.

FIG. 2 is an enlarged view of a region A1 illustrated in FIG. 1.

FIG. 3 is a plan view of the drill illustrated in FIG. 2 as viewed from a direction B1.

FIG. 4 is a plan view of the drill illustrated in FIG. 2 as viewed from a direction B2.

FIG. 5 is an enlarged view of a region A2 illustrated in FIG. 4.

FIG. 6 is an enlarged view of a region A2 illustrated in FIG. 4.

FIG. 7 is a schematic view illustrating a process of the method of manufacturing a machined product according to the embodiment.

FIG. 8 is a schematic view illustrating a process of the method of manufacturing a machined product according to the embodiment.

FIG. 9 is a schematic view illustrating a process of the method of manufacturing a machined product according to the embodiment.

### DESCRIPTION OF EMBODIMENTS

The following describes in detail a drill according to an embodiment using the drawings. In addition, in each of the drawings referred to below, for convenience of description, only main members among members constituting the embodiment are illustrated in a simplified manner. Accordingly, the drill may include any constituent member not illustrated in each drawing to which the present specification refers. Further, the dimensions of the members in each of the drawings do not faithfully represent the actual dimensions of the constituent members and the dimension ratios of each of the members.

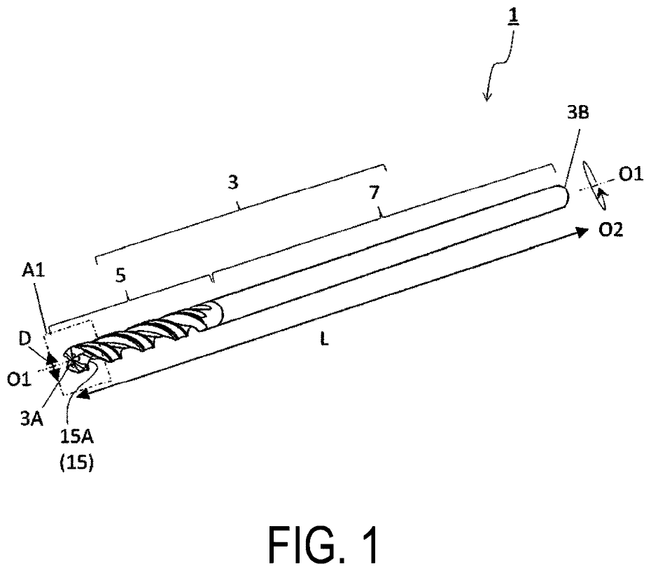

A drill 1 according to an embodiment of the present disclosure includes a body 3 that has a substantially cylindrical shape and that extends along a rotation axis O1 from a front end 3A toward a rear end 3B, as in the example illustrated in FIG. 1. The body 3 can perform drilling while rotating in a rotation direction O2 about the rotation axis O1.

In the example illustrated in FIG. 1, the body 3 includes a cutting portion 5 located on the front end 3A side and a shank portion 7 located on the rear end 3B side of the cutting portion 5. The shapes of the cutting portion and the shank portion are not particularly limited, but in the drill of the present embodiment, since the body has a substantially cylindrical shape, the cutting portion and the shank portion also have a substantially cylindrical shape.

The cutting portion 5 includes a part that comes into contact with the workpiece, and this part plays a key role in machining the workpiece. The shank portion 7 is a part gripped by a rotating spindle or the like in a machine tool and may be designed according to the shape of the spindle.

The cutting portion 5 and the shank portion 7 may be separate members or may be integrally formed. In general, the drill 1 in which the cutting portion 5 and the shank portion 7 are made of separate members is called a front end replacement type, and the drill 1 in which the cutting portion 5 and the shank portion 7 are integrally formed is called a solid type.

The outer diameter of the body 3 of the embodiment may be set to, for example, 0.5 mm to 4 mm. When the length in a direction in which the rotation axis O1 extends is L and the outer diameter is D, in the body 3 of the embodiment, the relationship between L and D can be set to, for example, L=1D to 10D. In a case where the outer diameter of the cutting portion 5 and the outer diameter of the shank portion 7 are different from each other, the outer diameter of the cutting portion 5 is defined as the outer diameter D of the body 3.

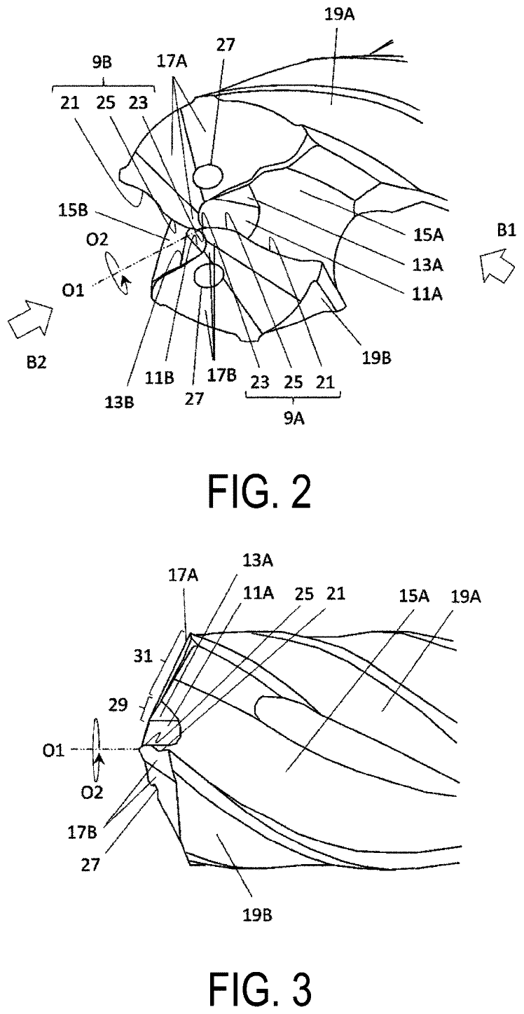

The cutting portion 5 includes a cutting edge 9, a thinning flute 11, a discharge flute 15, a front end surface 17, and an outer peripheral surface 19. As illustrated in FIGS. 2 and 3, the cutting edge 9 is located on the front end 3A side of the body 3. Since the cutting edge 9 is generally called a front end edge, the cutting edge 9 may also be referred to as a front end edge. FIG. 3 is a plan view of the drill 1 as viewed from a direction orthogonal to the rotation axis O1, and may also be referred to as a side view. The thinning flute 11 and the discharge flute 15 are flutes extending from the cutting edge 9 to the rear end 3B side. The front end surface 17 is a surface located on the front end 3A side and facing the front end 3A side. The outer peripheral surface 19 is a surface located on the outer peripheral side of the cutting portion 5.

In a case where the cutting portion 5 has one or more cutting edges 9, the numbers of the thinning flutes 11, the discharge flutes 15, the front end surfaces 17, and the outer peripheral surfaces 19 may each correspond to the number of the cutting edges 9. In the example illustrated in FIG. 2, since the number of the cutting edges 9 is two, the numbers of the thinning flutes 11, discharge flutes 15, front end surfaces 17, and outer peripheral surfaces 19 are also two each.

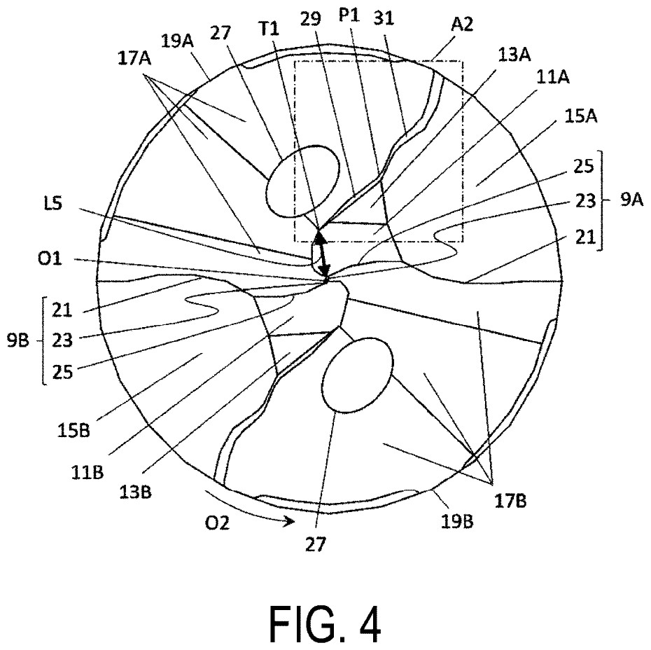

As illustrated in FIG. 4, the cutting edge 9 includes a main cutting edge 21 extending from the rotation axis O1 side toward the outer peripheral surface 19 side. An end portion of the main cutting edge 21 on the rotation axis O1 side is located on the front end 3A side of an end portion of the main cutting edge 21 on the outer peripheral surface 19 side. The main cutting edge 21 refers to a portion of the cutting edge 9 that is located on a ridge where the front end surface 17 and the discharge flute 15 intersect with each other and at which a rake angle has a positive value. At this time, the front end surface 17 functions as a flank face, and the discharge flute 15 functions as a rake face. FIG. 4 is a plan view of the drill 1 viewed from the front end 3A side along the rotation axis O1, and may be referred to as a front view or a front end view.

When the body 3 is viewed in the front end view as in the example illustrated in FIG. 4, the cutting edge 9 includes a chisel edge 23 including the rotation axis O1 and a thinning edge 25 extending from the chisel edge 23 toward the outer peripheral surface 19 of the body 3.

The thinning edge 25 refers to a portion of the cutting edge 9 that is positioned on a ridge where the front end surface 17 and the thinning flute 11 intersect with each other and at which a rake angle has a negative value. In the example illustrated in FIG. 4, the thinning edge 25 may be located on the rotation axis O1 side of the main cutting edge 21, and is connected to the main cutting edge 21. In the front end view, the chisel edge 23, the thinning edge 25, and the main cutting edge 21 of the cutting edge 9 are arranged in this order from the rotation axis O1 toward the outer periphery.

In a case where the cutting portion 5 has a plurality of front end surfaces 17, the chisel edge 23 refers to a portion of the cutting edge 9 that is located on a ridge where the plurality of front end surfaces 17 intersect with each other, and functions as a pseudo cutting edge. The chisel edge 23 in the example illustrated in FIG. 4 intersects with the rotation axis O1 and is connected to the thinning edge 25.

Here, in a case where the cutting portion 5 has a plurality of cutting edges 9, one of the plurality of cutting edges 9 is defined as a first cutting edge 9A, and a cutting edge 9 located forward of the first cutting edge 9A in the rotation direction O2 is defined as a second cutting edge 9B. In the example illustrated in FIG. 4, the first cutting edge 9A and the second cutting edge 9B each have the main cutting edge 21, the chisel edge 23, and the thinning edge 25. In the front end view, the second cutting edge 9B is located forward of the first cutting edge 9A in the rotation direction O2 via the thinning flute 11 (or the discharge flute 15) and the front end surface 17.

In a case where the cutting portion 5 has three or more cutting edges 9, the cutting edge 9 located forward of the first cutting edge 9A in a rotation direction O2 and closest to the first cutting edge 9A forward in the rotation direction O2 is defined as the second cutting edge 9B.

The thinning flute 11 is a flute located on the front end 3A side of the cutting portion 5. The thinning flute 11 is provided to reduce the core thickness of the cutting portion 5 on the front end 3A side. Therefore, the surface located on the rear side in the rotation direction O2 is inclined so as to be directed to the front side in the rotation direction O2 toward the rear end 3B. The thinning flute 11 may be formed by grinding with a grindstone or the like. In the example illustrated in FIG. 4, the cutting portion 5 has a plurality of thinning flutes 11 separated from each other via the front end surface 17 in the front end view.

In a case where the cutting portion 5 includes a plurality of thinning flutes 11, among the plurality of thinning flutes 11, a flute extending from the first cutting edge 9A toward the rear end 3B side is referred to as a first thinning flute 11A. Among the plurality of thinning flutes 11, a flute extending from the second cutting edge 9B toward the rear end 3B side is referred to as a second thinning flute 11B. The second thinning flute 11B is located forward of the first thinning flute 11A in the rotation direction O2.

The thinning flute 11 may have a thinning surface 13 located on the front side in the rotation direction O2. The shape of the thinning surface 13 is not particularly limited, but may be a planar shape. In a case where the cutting portion 5 has a plurality of thinning flutes 11, the cutting portion 5 may have a plurality of thinning surfaces 13. In the example illustrated in FIG. 4, the first thinning flute 11A has a first thinning surface 13A, and the second thinning flute 11B has a second thinning surface 13B.

The discharge flute 15 is generally called a flute and is located on the outer peripheral side of the thinning flute 11. The discharge flute 15 is provided to discharge chips to the rear end 3B side. Therefore, the surface located on the rear side in the rotation direction O2 is generally inclined rearward in the rotation direction O2 toward the rear end 3B. The discharge flute 15 extends to the rear end 3B side of the thinning flute 11. The thinning flute 11 and the discharge flute 15 are open and connected to each other. In the example illustrated in FIG. 1, the discharge flute 15 extends in a twisting manner around the rotation axis O1 from the cutting edge 9 toward the rear end 3B; however, the discharge flute 15 may extend in a linear manner.

In the present disclosure, “extending in a twisting manner” means that the discharge flute 15 extends in a substantially twisted manner from the front cutting edge 9 toward the rear end 3B side. As illustrated in FIG. 1, the discharge flute 15 may extend in a spiral shape. The discharge flute 15 may have a partially non-twisted portion. When the discharge flute 15 extends in a twisted manner, the twist angle of the discharge flute 15 is not limited to a specific value and may be set to, for example, about from 10° to 35°.

In the example illustrated in FIG. 4, the cutting portion 5 has a plurality of discharge flutes 15 separated from each other via the front end surface 17. In such a case, among the plurality of flutes, a flute extending from the first cutting edge 9A toward the rear end 3B side is referred to as a first discharge flute 15A, and a flute extending from the second cutting edge 9B toward the rear end 3B side is referred to as a second discharge flute 15B. The second discharge flute 15B is located forward of the first discharge flute 15A in the rotation direction O2.

The front end surface 17 may have a plurality of inclined flat surfaces or may have a curved surface shape. The front end surface 17 may have an opening portion 27 through which coolant is discharged. In this case, the coolant flows through a flow passage inside the body 3 and is discharged from the opening portion 27.

In the example illustrated in FIG. 4, the thinning flute 11 and the discharge flute 15 are located between the plurality of front end surfaces 17. In such a case, one of the plurality of front end surfaces 17 is defined as a first front end surface 17A, and the front end surface 17 located forward of the first front end surface 17A in the rotation direction O2 is defined as a second front end surface 17B.

The first front end surface 17A is adjacent to the first thinning flute 11A and the first discharge flute 15A on the front side in the rotation direction O2. To be specific, as illustrated in FIG. 4, in the front end view, the first front end surface 17A is located forward of the flutes in the rotation direction O2, and the first front end surface 17A is in contact with the flutes. The first front end surface 17A may be connected to the second cutting edge 9B at a rear side in the rotation direction O2. Since the first front end surface 17A is a surface extending from the second cutting edge 9B toward the first thinning flute 11A and the first discharge flute 15A, it may also be referred to as a flank face with respect to the second cutting edge 9B.

The above-described relationship also holds when the first front end surface 17A, the first thinning flute 11A, the first discharge flute 15A, and the second cutting edge 9B are replaced with the second front end surface 17B, the second thinning flute 11B, the second discharge flute 15B, and the first cutting edge 9A, respectively.

The outer peripheral surface 19 is a surface region located at an outer edge of the cutting portion 5. The outer peripheral surface 19 may have a margin or a clearance. In the example illustrated in FIG. 2, the cutting portion 5 has a plurality of outer peripheral surfaces 19 separated from each other via the discharge flute 15. When the cutting portion 5 has a plurality of outer peripheral surfaces 19, one of the plurality of outer peripheral surfaces 19 is defined as a first outer peripheral surface 19A, and an outer peripheral surface 19 located forward of the first outer peripheral surface 19A in the rotation direction O2 is defined as a second outer peripheral surface 19B.

In a case where the first outer peripheral surface 19A is rotated about the rotation axis O1, the first outer peripheral surface 19A may overlap the second outer peripheral surface 19B. Specifically, in the example illustrated in FIG. 4, each outer peripheral surface 19 is 180° rotationally symmetric about the rotation axis O1. The above-described relationship also holds when the first outer peripheral surface 19A is replaced with the first cutting edge 9A, the first thinning flute 11A, the first discharge flute 15A, or the first front end surface 17A.

The cutting portion 5 has a first honing surface 29 located at the intersection of the first front end surface 17A and the first thinning flute 11A. The cutting portion 5 has a second honing surface 31 located at the intersection of the first front end surface 17A and the first discharge flute 15A. As illustrated in FIG. 4, in the front end view, the first honing surface 29 and the second honing surface 31 each extend from the rotation axis O1 side toward the outer peripheral side of the body 3.

The first honing surface 29 is connected to the second honing surface 31. A connection portion between the first honing surface 29 and the second honing surface 31 is referred to as a first connection portion P1. The first honing surface 29 and the second honing surface 31 form a continuous honing surface. The second honing surface 31 may be connected to the first outer peripheral surface 19A.

The first honing surface 29 includes a first portion 33. The first portion 33 is located on the outer peripheral side of the first honing surface 29 and is connected to the second honing surface 31 at the first connection portion P1.

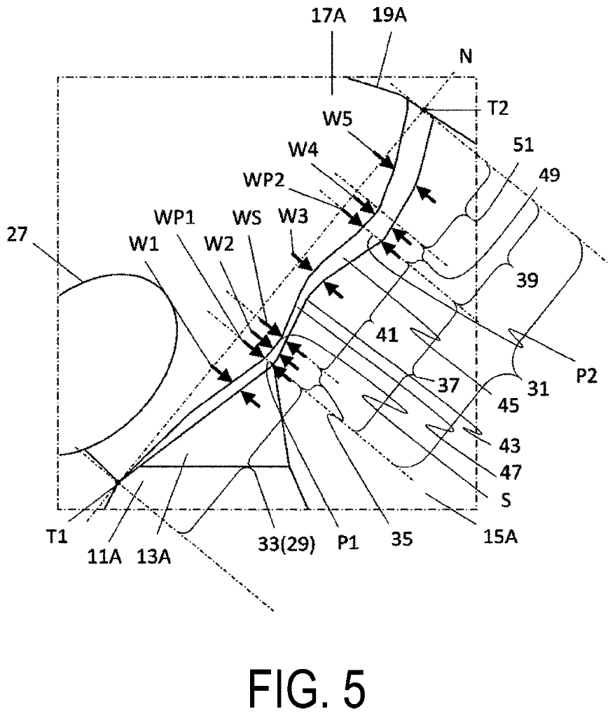

The width of the first portion 33 increases toward the second honing surface 31. Here, as illustrated in FIG. 5, the width of the first portion 33 refers to a width W1 in a direction perpendicular to an imaginary straight line N passing through an end point T1 on the rotation axis O1 side of the first honing surface 29 and an end point T2 on the outer peripheral side of the second honing surface 31 in the front end view. The width W1 of the first portion 33 may be from 5 μm to 30 μm. The amount of change in the width W1 of the first portion 33 may be from 3 μm to 25 μm. The sizes of the widths (W2 to W5, WP1, WP2) described below are also specified by the above-described method.

As illustrated in FIG. 5, when the second honing surface 31 is wide on the outer peripheral side in the front end view and the end point cannot be determined, the middle point of the width of the second honing surface 31 on the outer peripheral side in the circumferential direction of the rotation axis O1 is set as the end point T2 on the outer peripheral side of the second honing surface 31.

The expression “the width of the first portion 33 increases toward the second honing surface 31” does not necessarily mean that the width of the first portion 33 continuously increases, and there may be portions where the width is constant. Even in a case where another portion (the second portion 35 to the fifth portion 51) to be described later increases in size as it comes closer to a certain portion, in other words, increases in a certain direction, the width of each portion does not necessarily need to increase continuously, and there may be portions where the width is constant.

The second honing surface 31 includes a second portion 35. With regard to the second portion 35, as illustrated in FIG. 5, the second portion 35 is located on the rotation axis O1 side of the second honing surface 31, and is connected to the first honing surface 29 at the first connection portion P1. The second portion 35 is connected to the first portion 33 at the first connection portion P1.

The width of the second portion 35 in the front end view increases toward the first honing surface 29. As illustrated in FIG. 5, an inclination angle W2 of the second portion 35 may be from 3 μm to 30 μm. The amount of change in the width W2 of the second portion 35 may be from 2 μm to 25 μm.

Chips generated at the time of machining may collide with a boundary portion between the flank face and the thinning flute and a boundary portion between the flank face and the discharge flute 15, and damage may occur in these boundary portions. This is because the boundary portion has an angular shape, and thus the strength of the boundary portion is likely to decrease. In particular, in the vicinity of the intersection point where the flank face, the thinning flute, and the discharge flute intersect, a protruding shape such as a pointed shape or a convex curved shape is likely to be formed, and thus damage due to chip collision is likely to occur.

When such damage occurs, the center of gravity of the drill is shifted, and, consequently, the straight traveling stability of the drill during machining is impaired. This leads to a decrease in the accuracy of the machining process, and, consequently, the drill may need to be replaced at an early stage.

As one means for solving the above problem, a honing surface is provided on the flank face. As a result, the occurrence of damage in the boundary portion due to collision with chips can be avoided, and a long life for the tool can be realized.

However, if the honing surface is excessively provided with respect to the flank face, the wall thickness of the body is reduced, and the rigidity of the drill may be reduced. That is, if the honing surface is excessively provided, the life of the tool may become rather shortened. In the above case, the chips colliding with the honing surface may not flow to the flute but to the flank face side, and the chip discharging property of the drill may deteriorate.

In the drill 1 according to the present embodiment, the width of the first portion 33 in the first honing surface 29 increases toward the second honing surface 31, and the width of the second portion 35 in the second honing surface 31 increases toward the first honing surface 29.

Since the drill 1 has the above-described configuration, the widths of the honing surfaces can be relatively increased at the portion where the three of the first front end surface 17A, the first thinning flute 11A, and the first discharge flute 15A intersect. This reduces damage in areas where chips tend to collide.

Since excessive honing of the flank face is avoided, the thickness of the body 3 is secured, the rigidity of the drill 1 is easily maintained, and at the same time, excellent performance is provided in terms of chip discharge.

Therefore, the drill of the present embodiment is a drill that achieves reduction in the occurrence of damage due to collision with chips, maintenance of the rigidity of the body, and excellent chip discharging property.

In the front end view, the first portion 33 may extend rearward in the rotation direction O2 of the rotation axis O1 toward the second honing surface 31, and the second portion 35 may extend rearward in the rotation direction O2 of the rotation axis O1 toward the first honing surface 29. In the example illustrated in FIG. 4, the entire honing surface composed of the first honing surface 29 and the second honing surface 31 has a protruding shape protruding rearward in the rotation direction O2 with the first connection portion P1 as the apex.

In such a case, since the vicinity of the intersection of the first front end surface 17A, the first thinning flute 11A, and the first discharge flute 15A has a more protruding shape, the occurrence of damage is reduced by provision of the first portion 33 and the second portion 35.

As illustrated in FIG. 5, the entirety of the first honing surface 29 may be the first portion 33. In other words, the width of the first honing surface 29 increases toward the second honing surface 31.

Since chips generated during machining are discharged along the thinning flute 11 and the discharge flute 15, the chips have a twisted shape around the rotation axis O1, and the amount of chips generated increases the closer the chips are located to the outer peripheral side. The load due to the chip collision applied to the portion located on the outer peripheral side of the body 3 also increases in proportion to the amount of chips generated. Therefore, the width of the honing surface on the outer peripheral side may be larger than the width of the honing surface on the rotation axis O1 side.

Therefore, in the case where the drill 1 has the above-described configuration, the risk of damage to the drill 1 due to collision with chips can be reduced while ensuring high rigidity and good chip discharging property of the drill 1.

As illustrated in FIG. 5, the second honing surface 31 may include a first region 37, and a second region 39 located on the outer peripheral side of the first region 37. The first region 37 may have a recessed shape with a depression toward the front in the rotation direction O2 in the front end view. The second region 39 may extend forward in the rotation direction O2 toward the outer peripheral side in the front end view. The first region 37 may be connected to the second region 39, and a connection portion in this case is referred to as a second connection portion P2.

The chips generated during machining may collide with the first region 37 when flowing from the first thinning flute 11A to the first discharge flute 15A. Here, when the first region 37 does not have a recessed shape, the collision of the chips is likely to become concentrated in the vicinity of the end portion of the first region 37 on the rotation axis O1 side. However, when the first region 37 has a recessed shape, the risk of chip collision can be dispersed to a portion on the outer peripheral side of the first region 37.

When the second region 39 extends forward in the rotation direction O2 toward the outer peripheral side, the first discharge flute 15A is widened, and thus the chip discharging property is further improved.

The first region 37 may have a third portion 41 that increases in width toward the outer peripheral surface 19. The third portion 41 may be connected to the second region 39 at the second connection portion P2, or may be connected to the second portion 35. In such a case, the risk of damage due to chip collision can be reduced while ensuring high rigidity and good chip discharging property of the drill 1. Further, as illustrated in FIG. 5, the width W3 of the third portion 41 may be from 5 μm to 50 μm. The amount of change in the width W3 of the third portion 41 may be from 3 μm to 45 μm.

The third portion 41 may include a bottom portion 43 of the first region 37. In the example illustrated in FIG. 5, the bottom portion 43 refers to a portion of the first region 37 in which the boundary between the first discharge flute 15A and the first region 37 is most recessed toward the front side in the rotation direction O2, and the bottom portion 43 may be referred to as being located at the end portion on the front side in the rotation direction O2. Here, in the first region 37, a region located on the outer peripheral side of the bottom portion 43 is referred to as an outer region 45, and a region located on the inner side of the outer region 45 is referred to as an inner region 47.

As illustrated in FIG. 5, since the outer region 45 faces the first thinning flute 11A side in the front end view, the chips flowing from the first thinning flute 11A more easily collide with the outer region 45 than the inner region 47. Therefore, when the body 3 has the above-described configuration, relatively wide honing is performed on the outer region 45, and thus damage due to chip collision is less likely to occur.

The second region 39 may have a fourth portion 49 that increases in width toward the first region 37. The fourth portion 49 may be connected to the first region 37 at the second connection portion P2. In the front end view, the fourth portion 49 is a portion located on the front side of the second region 39 in the rotation direction O2, that is, the fourth portion 49 is a protruding portion. Therefore, the risk of damage to the drill 1 due to collision with chips is high. Therefore, when the second region 39 has the above-described configuration, such a risk can be reduced. The width W4 of the fourth portion 49 illustrated in FIG. 5 may be from 10 μm to 100 μm. The amount of change in the width W4 of the fourth portion 49 may be from 2 μm to 80 μm.

The second region 39 may have a fifth portion 51 that increases in width toward the outer peripheral surface 19. The fifth portion 51 may be connected to the first outer peripheral surface 19A or may be connected to the fourth portion 49. In such a case, the risk of damage to the drill 1 due to collision with chips can be reduced while ensuring high rigidity and good chip discharging property of the drill 1. The width W5 of the fifth portion 51 illustrated in FIG. 5 may be from 15 μm to 150 μm. The amount of change in the width W5 of the fifth portion 51 may be from 5 μm to 120 μm.

As illustrated in FIG. 5, the width WP1 of the first connection portion P1 may be smaller than the width WP2 of the second connection portion P2. In this case, excessive honing near the first connection portion P1 can be reduced and the wall thickness of the body 3 near the first connection portion P1 can be maintained. The first connection portion P1 may be located forward of the second connection portion P2 in the rotation direction O2 in the front end view.

When a portion where the width of the second honing surface 31 is minimized is defined as a smallest portion S, the first region 37 may have the smallest portion S. To be specific, as illustrated in FIG. 5, the smallest value of the width W1 of the first region 37 may be the width WS of the smallest portion S. In such a case, since the width of the second region 39 is relatively large, damage due to chip collision is less likely to occur on the outer peripheral side of the body 3.

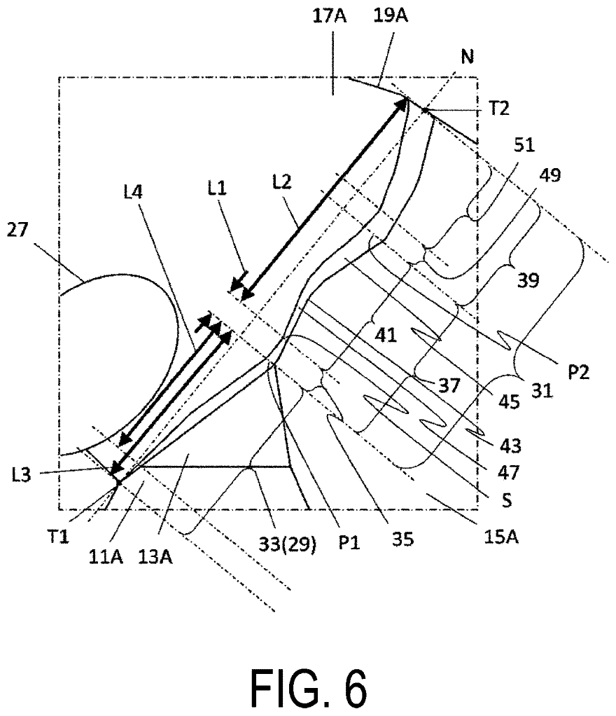

When a distance from an end portion of the second honing surface 31 on the rotation axis O1 side to the smallest portion S is L1 and a distance from the smallest portion S to an end portion of the second honing surface 31 on the outer peripheral side is L2, L2/L1≥5 may be satisfied. To be specific, as illustrated in FIG. 6, in the direction along the imaginary straight line N, the relationship between the distance L1 from the first connection portion P1 to the smallest portion S and the distance L2 from the smallest portion S to the second connection portion P2 may be L2/L1≥5. In such a case, since the width of the honing surface from the smallest portion S to the outer peripheral side gradually increases, damage due to chip collision is unlikely to occur on the outer peripheral side of the body 3.

The first thinning flute 11A may have a first thinning surface 13A connected to the first portion 33. The length of the first honing surface 29 may be longer than the length of the boundary portion between the first front end surface 17A and the first thinning surface 13A. To be more specific, as illustrated in FIG. 6, when L4 is the length of the boundary portion between the first front end surface 17A and the first thinning surface 13A, the length L3 of the first honing surface 29 in the direction along the imaginary straight line N may be L3>L4. In such a case, the risk of damage due to chip collision can be reduced in the portion located near the rotation axis O1.

In the front end view, the distance from the rotation axis O1 to an end portion of the first honing surface 29 on the rotation axis O1 side may be smaller than one third of the outer diameter of the body 3. Specifically, the relationship between the distance L5 from the rotation axis O1 to an end point T1 of the first honing surface 29 on the rotation axis O1 side illustrated in FIG. 4 and the outer diameter D of the body 3 may be L5>D/3. In such a case, the risk of damage due to chip collision can be reduced in the portion located near the rotation axis O1.

The first honing surface 29 may be longer than the second honing surface 31 in the direction along the imaginary straight line N. In this case, since the length of the second honing surface 31 is relatively large, the first discharge flute 15A is also relatively wide. Thus, chip discharging property is further improved. In the direction along the imaginary straight line N, the first region 37 may be longer than the second region 39, and the first portion 33 may be longer than the other portions. The third portion 41 may be longer than the second portion 35, and the fifth portion 51 may be longer than the fourth portion 49.

To be specific, the length of the first honing surface 29 in the direction along the imaginary straight line N may be from 0.05D to 0.2D. The length of the second honing surface 31 may be from 0.2D to 0.4D. The length of the first region 37 may be from 0.2D to 0.38D. The length of the second region 39 may be from 0.02D to 0.2D. The length of the first portion 33 may be from 0.05D to 0.2D. The length of the second portion 35 may be from 0.01D to 0.1D. The length of the third portion 41 may be from 0.15D to 0.38D. The length of the fourth portion 49 may be from 0.02D to 0.2D. The length of the fifth portion 51 may be from 0.01D to 0.1D.

In addition to the first honing surface 29 and the second honing surface 31, the body 3 may include a honing surface having the same configuration as the first honing surface 29 or the second honing surface 31. For example, a honing surface having the same configuration as the first honing surface 29 or the second honing surface 31 may be provided at the boundary between the second front end surface 17B and the second thinning flute 11B. A honing surface having the same configuration as the first honing surface 29 or the second honing surface 31 may be provided at the boundary between the second front end surface 17B and the second discharge flute 15B and at the boundary between the second front end surface 17B and the second outer peripheral surface 19B. The number of honing surfaces included in the drill 1 is not particularly limited. For example, in a case where the drill 1 has three cutting edges, the drill 1 may include three honing surfaces.

The material of the body 3 includes cemented carbide alloy and cermet or the like, for example. The composition of the cemented carbide alloy includes WC—Co, WC—TiC—Co, and WC—TiC—TaC—Co, for example. Here, WC, TiC, and TaC are hard particles, and Co is a binder phase. Cermet is a sintered composite material in which a metal is combined with a ceramic component. Specifically, examples of the cermet include a titanium compound containing titanium carbide (TiC) or titanium nitride (TiN) as a main component.

The surface of the body 3 may be coated with a coating film using a chemical vapor deposition (CVD) method or a physical vapor deposition (PVD) method. Examples of the composition of the coating film include titanium carbide (TiC), titanium nitride (TiN), titanium carbonitride (TiCN), and alumina (Al₂O₃).

### Method for Manufacturing Machined Product

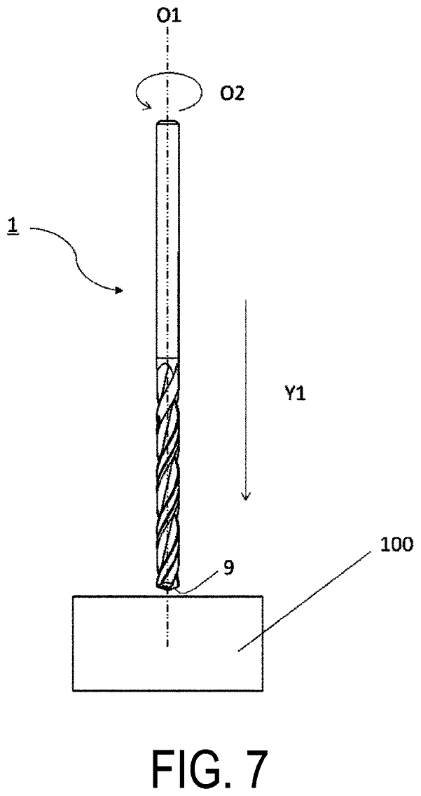

Next, a method of manufacturing a machined product according to an embodiment of the present disclosure will be described in detail with reference to an example in which the drill 1 according to the above-described embodiment is used. Hereinafter, description will be given with reference to FIGS. 7 to 9.

A method of manufacturing a machined product according to an embodiment of the present disclosure includes the steps of: (1) rotating the drill 1 about the rotation axis O1; (2) bringing the cutting edge 9 of the drill 1 that is rotating into contact with a workpiece 100; and (3) separating the drill 1 from the workpiece 100.

More specifically, first, as illustrated in FIG. 7, the drill 1 is rotated about the rotation axis O1 and moved in a direction (Y1 direction) along the rotation axis O1, thereby bringing the drill 1 relatively close to the workpiece 100.

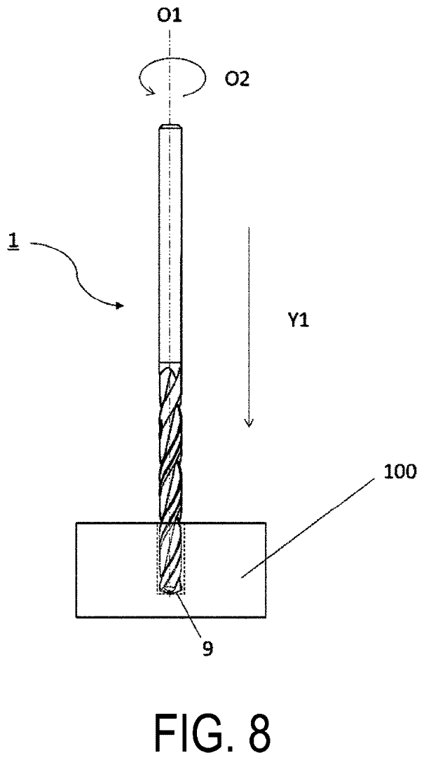

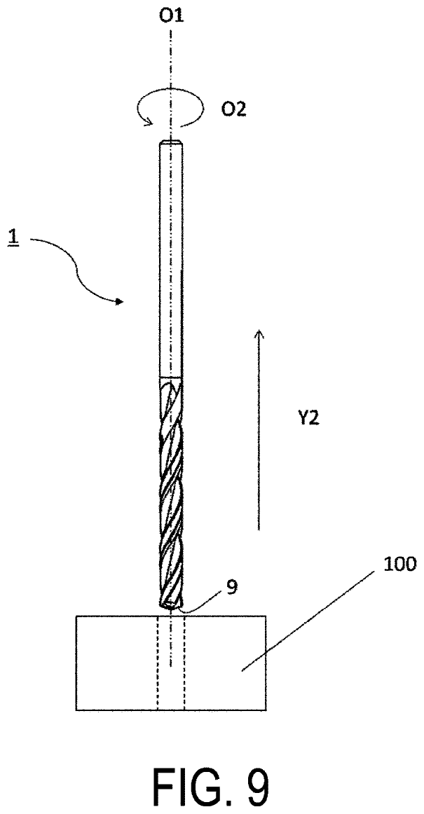

As illustrated in FIG. 8, the cutting edge 9 of the drill 1 is brought into contact with the workpiece 100 to machine the workpiece 100. As illustrated in FIG. 9, by moving the drill 1 in a direction Y2, the drill 1 is relatively moved away from the workpiece 100.

In the embodiment, the drill 1 is brought close to the workpiece 100 in a state where the workpiece 100 is fixed and the drill 1 is rotated about the rotation axis O1. In FIG. 8, the workpiece 100 is machined by bringing the cutting edge 9 of the drill 1 that is rotating into contact with the workpiece 100. In FIG. 9, the drill 1 is moved away from the workpiece 100 in a rotated state.

In the machining using the manufacturing method according to the embodiment of the present disclosure, the drill 1 is brought into contact with the workpiece 100 or the drill 1 is separated from the workpiece 100 by moving the drill 1 in each step. Naturally, the present invention is not limited to such a configuration.

For example, in the step (1), the workpiece 100 may be brought close to the drill 1. In addition, in the step (3), the workpiece 100 may be moved away from the drill 1. In the case of continuing the machining, the step of bringing the cutting edge 9 of the drill 1 into contact with a different portion of the workpiece 100 may be repeated while maintaining the state in which the drill 1 is rotated.

Typical examples of the material of the workpiece 100 include aluminum, carbon steel, alloy steel, stainless steel, cast iron, and nonferrous metal, or the like.

### REFERENCE SIGNS

1 Drill
3 Body
3A Front end
3B Rear end
5 Cutting portion
7 Shank portion
9 Cutting edge
9A First cutting edge
9B Second cutting edge
11 Thinning flute
11A First thinning flute
11B Second thinning flute
13 Thinning surface
13A First thinning surface
13B Second thinning surface
15 Discharge flute
15A First discharge flute
15B Second discharge flute
17 Front end surface
17A First front end surface
17B Second front end surface
19 Outer peripheral surface
19A First outer peripheral surface
19B Second outer peripheral surface
21 Main cutting edge
23 Chisel edge
25 Thinning edge
27 Opening portion
29 First honing surface
31 Second honing surface
33 First portion
35 Second portion
37 First region
39 Second region
41 Third portion
43 Bottom portion
45 Outer region
47 Inner region
49 Fourth portion
51 Fifth portion
100 Workpiece
O1 Rotation axis
O2 Rotation direction
L Length of body
L1 to L5 Length (distance)
D Outer diameter of body
P1, P2 Connection portion
T1, T2. End point
N Imaginary straight line
W1 to W5 Width of each portion
WP1, WP2 Width of connection portion
S. Smallest portion
WS Width of smallest portion
Y1, Y2 Movement direction

1. A drill comprising:
a body that is rod-shaped and that extends from a front end toward a rear end along a rotation axis, wherein
the body comprises
a cutting edge located on the front end side,
a thinning flute extending from the cutting edge toward the rear end,
a discharge flute located on an outer peripheral side of the thinning flute and extending from the cutting edge toward the rear end,
a front end surface adjacent to the thinning flute and the discharge flute forward in a rotation direction of the rotation axis,
a first honing surface located at an intersection of the front end surface and the thinning flute, and
a second honing surface located at an intersection of the front end surface and the discharge flute and connected to the first honing surface, and
the first honing surface comprises a first portion that is connected to the second honing surface and that has a width that increases toward the second honing surface in a front end view, and
the second honing surface comprises a second portion that is connected to the first honing surface and that has a width that increases toward the first honing surface in the front end view.

2. The drill according to claim 1, wherein
in the front end view,
the first portion extends rearward in the rotation direction toward the second honing surface, and
the second portion extends rearward in the rotation direction toward the first honing surface.

3. The drill according to claim 1, wherein
all of the first honing surface is the first portion.

4. The drill according to claim 1, wherein
in the front end view,
the second honing surface further comprises
a first region having a recessed shape recessed forward in the rotation direction, and
a second region located on the outer peripheral side of the first region and extending forward in the rotation direction toward the outer peripheral side.

5. The drill according to claim 4, wherein
the body comprises an outer peripheral surface located at an outer edge, and
the first region comprises
the second portion, and
a third portion that is connected to the second region and, in the front end view, has a width that increases toward the outer peripheral surface.

6. The drill according to claim 5, wherein
the first region further comprises a bottom portion located at an end portion forward in the rotation direction, and
the third portion comprises the bottom portion.

7. The drill according to claim 4, wherein
the second region comprises a fourth portion comprising an end portion connected to the first region and, in the front end view, having a width that increases toward the first region.

8. The drill according to claim 4, wherein
the second region comprises a fifth portion comprising an end portion on the outer peripheral side and, in the front end view, having a width that increases toward the outer peripheral side.

9. The drill according to claim 4, wherein,
the first region is connected to the second region, and
when a portion where the first honing surface and the second honing surface meet is defined as a first connection portion, and a portion where the first region and the second region meet is defined as a second connection portion,
in the front end view,
a width of a honing surface in the first connection portion is smaller than a width of a honing surface in the second connection portion.

10. The drill according to claim 4, wherein
when a portion where a width of the second honing surface is smallest is defined as a smallest portion,
the first region comprises the smallest portion.

11. The drill according to claim 10, wherein
in the front end view,
when a distance from an end portion of the second honing surface on the rotation axis side to the smallest portion is defined as L1, and a distance from the smallest portion to an end portion of the second honing surface on the outer peripheral side is defined as L2,
$$L 2 / L 1 \geq 5 .$$

12. The drill according to claim 1, wherein
the thinning flute comprises a thinning surface connected to the first portion, and
a length of the first honing surface is longer than a length of a boundary portion between a first front end surface and a first thinning surface.

13. The drill according to claim 1, wherein
in the front end view,
a distance from the rotation axis to an end portion of the first honing surface on the rotation axis side is less than one third of an outer diameter of the body.

14. A method of manufacturing a machined product, the method comprising:
rotating the drill according to claim 1;
bringing the drill that is rotating into contact with a workpiece; and
separating the drill from the workpiece.
